(19) United States
(12) Patent Application Publication
(10) Pub. No.: US 2004/0236628 A1
(43) Pub. Date: Nov. 25, 2004

(54) Method of marketing or promoting consumer goods

(76) Inventors: James Kemp, Somerset, NJ (US); Al Sprosta, Union, NJ (US); Brett Traficant, Clark, NJ (US); Tau Dai, Edison, NJ (US); Eduardo Jimenez, Manalapan, NJ (US); Nancy Won Mee Pak, New York, NY (US)

Correspondence Address: FROMMER LAWRENCE & HAUG LLP, 745 FIFTH AVENUE, NEW YORK, NY, 10151, US

(21) Appl. No.: 10/442,784

(22) Filed: May 21, 2003

(51) Int. Cl. G06F 17/60

(52) U.S. Cl. 705/14

(57) ABSTRACT

A method for marketing or promoting an item is provided that has an item in a first consumer product, for example, a toothbrush assembly, such that the item can be removed from the toothbrush assembly and later used in a second consumer product, such as a toy set.

### BACKGROUND OF THE INVENTION

A. Field of the Invention

The present invention relates generally to a method of marketing or promoting an item, such as a figurine or toy, in one consumer good and later using the item in another consumer good. More particularly, the present invention relates to a method for marketing or promoting a figurine or toy in a toothbrush assembly, wherein the toothbrush assembly has a handle with a compartment for removably storing the figurine or toy. Upon removing the figurine or toy from the compartment, the figurine or toy can be used in another consumer good, such as a toy set.

B. Description of the Related Art

It takes considerable effort to market items in creative and appealing ways to consumers. One such way is the so-called “cross-promotion,” wherein one consumer good promotes or markets a non-competitor's goods or services. A classic example is the ubiquitous McDonald's Happy Meal™, wherein a toy or promotional item, for example, a figurine of a cartoon character, is provided in the box containing a child's meal.

It takes considerably more effort, however, to promote proper dental habits in children. Children have notoriously short attention spans, and developing a routine for purposes of long-term hygiene can be most challenging. Various types of toothbrushes having object-shaped handles are generally known in the art, and are designed to appeal to children to encourage them to brush their teeth for enhanced oral health. Examples of such toothbrushes that appeal to children include U.S. Design Pat. Nos. 237,659, 443,765, 452,381, and 452,382 disclose toothbrushes having handles shaped like vehicles (e.g., race cars, rocket ships, jets, etc.). U.S. Design Pat. Nos. 329,948, 347,146, 347,147, 347,148, 363,166, 402,119, 434,907, and 452,380, and U.S. Pat. Nos. 5,353,464 and 6,026,532 disclose toothbrushes having handles shaped like animals. Toothbrush handles having other shapes are also possible, as seen in U.S. Design Pat. Nos. 113,744, 155,668, 175,198, and 209,574.

Many children's toys are handheld, and, especially with vehicle type handheld toys, contain a compartment with a lid for retaining figurines, such as toy people, therein. For example, the LEGO® Company of Denmark offers several vehicle type handheld toys that have a compartment with a transparent lid to retain a LEGO® figurine, such as a driver, within the vehicle. Such handheld toys are not known to have been used as toothbrush handles.

The closest the toothbrush art comes to offering toy-based handles with compartments for retaining additional figurines may be found in U.S. Pat. Nos. 5,353,464 and 5,590,436. U.S. Pat. No. 5,353,464 discloses a toothbrush having a handle in the general form of an animal. If desired, the handle can contain a hollowed-out compartment for storage of a detachably/attachable toothbrush head. The compartment can be fitted with a suitable cover, plug, or lid to encase the entire toothbrush head within the handle. However, the compartment of U.S. Pat. No. 5,353,464 is adapted to retain only the detachable toothbrush head, and there is no mention of providing a figurine within the handle.

U.S. Pat. No. 5,590,436 discloses a toothbrush having a handle that carries a figurine formed separately from but attached to the handle. The figurine can be attached directly to the handle of the toothbrush or can be attached first to a carrier which is then attached to the handle.

The toothbrush handle of U.S. Pat. No. 5,590,436 does not have a compartment with a cover or lid for retaining the figurine.

Although not part of the toothbrush art, U.S. Pat. No. 5,713,664 discloses a beverage stirrer having a pop out item such as a figurine, logo, or product replica. The pop out item can be mounted to an end of a sliding mechanism and can be configured to extend out of an open end of a casing as the beverage is stirred. Unfortunately, U.S. Pat. No. 5,713,664 fails to suggest that such a pop out item configuration can be used for a toothbrush handle.

Thus, there is a need in the art to appeal to children with a toy-shaped toothbrush handle having a compartment and a cover or lid for removably storing a figurine or other child's toy therein, wherein the handle can function as a toy with or without a detachable toothbrush head to encourage children to brush their teeth. There is also a need in the art to market consumer goods, such as toys and toothbrushes, that can capture a child's attention while fostering proper dental hygiene.

### SUMMARY OF THE INVENTION

This invention relates to marketing, promoting, cross-marketing or cross-promoting a first or second consumer good with an item. The item may be a vehicle, figurine, toy, or sundry product, or a novelty, promotional or collectible item. The item is designed to be, for example, displayed or stored in the first consumer product, such as a toothbrush; removed from the first consumer product; and, used with a second consumer product, such as a toy set. After using the item in the second consumer product, the item may be returned to the first consumer product for storage or display.

In accordance with one embodiment of the present invention, a method for marketing, promoting, cross-marketing or cross-promoting a first or second consumer product is provided by removably attaching an item to the first consumer product, wherein the item is adapted to be used with the second consumer product.

In accordance with one embodiment of the present invention, a powered toothbrush is provided for marketing, promoting, cross-marketing or cross-promoting a first or second consumer product by placing an item into the first consumer product, wherein the item is adapted to be removably attached to the first consumer product and adapted to be used with a second consumer product.

As embodied and broadly described herein, the present invention is preferably drawn to a method of marketing, promoting, cross-marketing or cross-promoting a first or second consumer product by removably attaching an item to a toothbrush assembly, the toothbrush assembly having a head connected to a neck, the head having an exposed outer surface; a plurality of bristles mounted to the head, the bristles being grouped into bristle tufts which extend outwardly from the exposed outer surface; a handle connected to the neck, the handle having a compartment provided therein and an opening that provides access to the compartment; and an item, such as a vehicle, figurine, other toy or sundry product, removably provided within the compartment of the handle, the vehicle, figurine, other toy or sundry product being provided removably and storeably within the compartment via the opening provided in the handle.

In various practices of the present invention, the toothbrush handle takes the form of a rocket ship having a compartment and a cover or lid for retaining a figurine, such as action figure, or a vehicle or another type toy or sundry product (hereinafter generally referred to as a “figurine”) therein; the compartment having a cover, or lid, or otherwise being openable and reclosable, such as by being in two parts or sections, which sections may be screwed together, force fit together, snapped-together, or hinged-together to form the compartment which holds the figurine. Preferably, the cover is transparent so that the figurine may be viewed within the rocket ship-shaped handle. The cover may preferably be opened and closed, or removed and replaced so that the figurine may be removed and stored in the handle compartment.

In another aspect of the present invention, the toothbrush handle rather than being in the form of a rocked ship takes the form of a vehicle (e.g., a rescue vehicle) having a compartment and a transparent cover for retaining a figurine, such as a toy driver, therein. The transparent cover of the vehicle-shaped handle may function as a windshield for the vehicle, and as discussed above may preferably be opened and closed, or removed and replaced so that the figurine may be removed and stored in the handle compartment.

In still another aspect of the present invention, the toothbrush handle may be a more conventional toothbrush shape, not the shape of a toy, but still acts as a storage and display case for the figurine contained in a compartment provided therein. An entirely transparent or translucent handle or an opaque handle with a transparent or translucent cover may be provided to enable the figurine to be displayed, and may preferably be opened and closed, or removed and replaced so that the figurine may be removed and stored in the handle compartment.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front elevational view of a toothbrush having a head and a rocket ship-shaped handle having a removable and replaceable cover that allows access to a compartment for storing a figurine therein in accordance with an embodiment of the present invention;

FIG. 2 is a side elevational view of the toothbrush shown in FIG. 1;

FIG. 3 is a rear elevational view of the toothbrush shown in FIGS. 1 and 2;

FIG. 4 is a top plan view of the toothbrush shown in FIGS. 1-3;

FIG. 5 is a bottom plan view of the toothbrush shown in FIGS. 1-4;

FIG. 6 is a front elevational view of the toothbrush handle shown in FIGS. 1-5, and showing a removable and replaceable cover held in place by a snap-in latch;

FIG. 7 is a cross-sectional view in elevation of the toothbrush handle shown in FIGS. 1-6, taken along line 7-7 of FIG. 6 and showing a snap-in latch provided in a receiver recess;

FIG. 8 is a front elevational view of the toothbrush handle shown in FIGS. 1-5, and showing an alternative embodiment with a hinged full cover with a snap-in latch;

FIG. 9 is a front elevational view of the toothbrush handle shown in FIGS. 1-5, and showing another alternative embodiment with a vertically-hinged two-piece cover with snap-in latches for each removable and replaceable cover;

FIG. 10 is a front elevational view of the toothbrush handle shown in FIGS. 1-5, and showing still another alternative embodiment with a horizontally-hinged two-piece cover with snap-in latches for each removable and replaceable cover and a figurine removed from the compartment of the toothbrush handle;

FIG. 11 is a side elevational view of a toothbrush having a removable head and neck (shown in phantom outline) and a vehicle-shaped handle having a removable and replaceable cover displaying a compartment that removably stores a figurine therein in accordance with still another embodiment of the present invention;

FIG. 12 is a front elevational view of the toothbrush shown in FIG. 11;

FIG. 13 is a fragmental rear view of the toothbrush shown in FIGS. 11 and 12, and showing how a retainer button of the toothbrush neck engages a retainer slot formed in the handle;

FIG. 14 is a side elevational view of a toothbrush having a removable head and neck, and a handle having a cover displaying a compartment that stores a figurine therein in accordance with still another embodiment of the present invention; and

FIG. 15 is a side elevational view of still another embodiment of a toothbrush of the present invention having a removable head and neck, and a handle having a cover displaying a compartment that stores a figurine therein.

### DETAILED DESCRIPTION OF EMBODIMENTS OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The present invention is broadly related to a method for marketing, promoting, cross-marketing or cross-promoting a first or second consumer product by removably attaching an item to the first consumer product, wherein the item is adapted to be used with the second consumer product. The item may be, for example, a vehicle, a figurine, a toy, or a sundry product. The item may also be, for example, a novelty, promotional or collectible item. In a preferred embodiment, the item is a toy.

In a preferred embodiment, the item is attached either on the inside or the outside of the first consumer product, most preferably on the inside. The item may be attached to either the inside or the outside of the first consumer product by any means known in the art such as, but not limited to, friction, snap-on, a capsule, a pouch, a string, a bar, an elastic or non-elastic band, or a “hook and loop” element such as, for example, VELCRO™.

The terms “marketing,” “promoting,” “cross-marketing” and “cross-promoting” are known terms in the art. The terms “cross-marketing” and “cross-promoting” include, for example, the synergistic effects of having both the first and second consumer goods marketed or promoted at the same time. The advantages of cross-marketing and cross-promoting are readily apparent to a skilled artisan.

The first consumer product is preferably a toothbrush assembly, a bottle or a storage device. Most preferably, the consumer product is a toothbrush assembly that is manual or powered, e.g. battery-powered. In a still further preferred embodiment, the toothbrush assembly has a head connected to a neck, the head having a plurality of bristles extending outwardly therefrom; a handle connected to the neck, the handle having a compartment provided therein; and a compartment within which the item is removably attached. The compartment comprises a cover which may be opened and reclosed whereby the item may be removed and replaced in the compartment. In a preferred embodiment, the cover of the compartment is transparent to make the item visible within the compartment of the handle the cover permanently connects to a body portion of the handle. The cover removably connects to a body portion of the handle via at least one snap-in latch. The cover connects to a body portion of the handle with at least one hinge and at least one snap-in latch. Preferably, the cover comprises two pieces, each cover piece connecting to the body portion of the handle via at least one hinge and at least one snap-in latch.

The handle of the toothbrush assembly includes a top section connected to the neck and a bottom section distal from the neck, the top and bottom sections being joined in such a manner as to be hinged or to be separable and rejoinable, wherein the top and bottom sections form the compartment which retains the item. Preferably, the handle comprises two sections connected together with an indicia band, preferably wherein the indicia band has threads that mate with threads provided on each section of the handle.

The lower portion of the neck includes a stiffener arm and a retainer button integrally connected to a spring arm, the retainer button, spring arm, and stiffener arm removably connecting to the opening of the handle. Preferably, the retainer button extends through a retainer slot provided in the handle, and remains in the retainer slot due to a spring force provided by the spring arm.

Preferably, the second consumer product is a toy, most preferably a toy set wherein the item is a component thereof. The item may be interchangeable between the first and second consumer products, such that after it is removed from the first consumer product and used with the second consumer product, it can be returned with the first consumer product after use. In a preferred embodiment, the consumer product, such as a toothbrush, can function as intended with or without the item attached thereto.

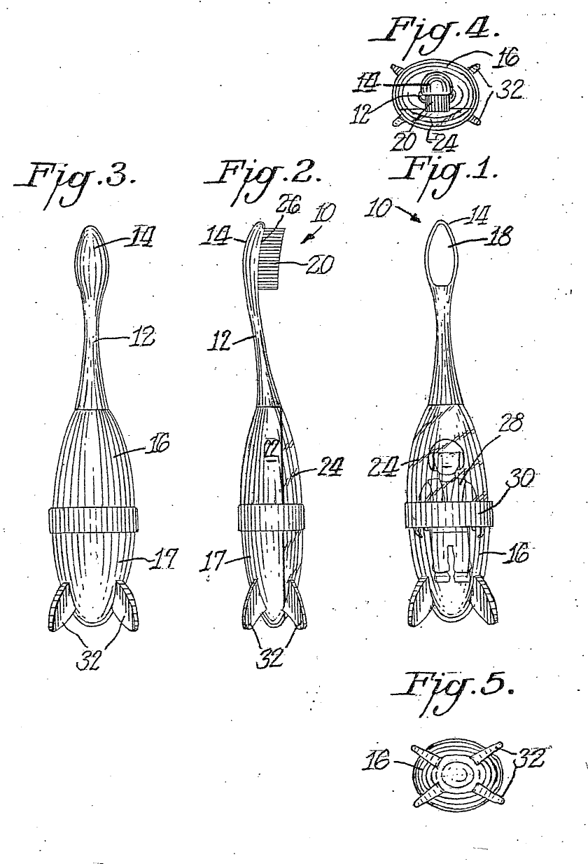

FIGS. 1-5 illustrate one practice of the present invention wherein a toothbrush 10 includes a neck section 12 interposed between a head 14 and a handheld handle 16. Preferably, neck 12 and head 14 are integrally connected, and together are detachably connected to handle 16 so that head 14 may be replaced as the bristles become worn and so that handle 16 may function separately as a toy when detached from neck 12 and head 14. In an alternate, less costly embodiment of the present invention, the head 14 and neck 12 are integral and permanently connected to the handle 16.

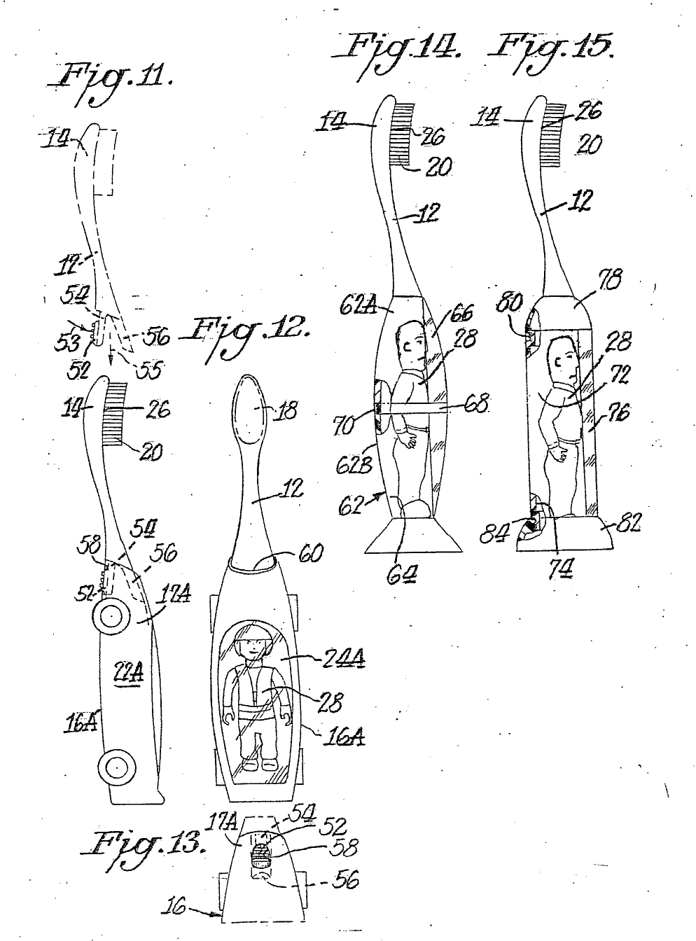

As further shown in FIGS. 1-5, handle 16 preferably includes a hollowed-out compartment 22 with a cover, window, or lid 24 for retaining a figurine 28, such as an action figure; however, it is understood that in place of the figurine may be a vehicle, such as a submarine, plane or other toy or sundry product, such as candy or a miniature toothpaste tube which will appeal to a child. Cover 24 may be hinged or otherwise fixedly attached to, such as by being removably snapped thereto, or integrally formed with a body portion 17 of handle 16 and may be transparent for displaying figurine 28 housed within compartment 22. Although cover 24 may be configured to be removable, if cover 24 is fixedly attached to handle 16, an access opening for compartment 22 should be provided where neck 12 connects to handle 16 (as described more fully below with reference to FIG. 11). An indicia band 30 may additionally be provided for displaying a toy logo. Since the embodiment of the handle 16 shown in FIGS. 1-5 is shaped like a rocket ship, it preferably includes fins 32 which simulate rocket ship fins, but also act as support feet for holding toothbrush 10 in an upright position for easy storage or display.

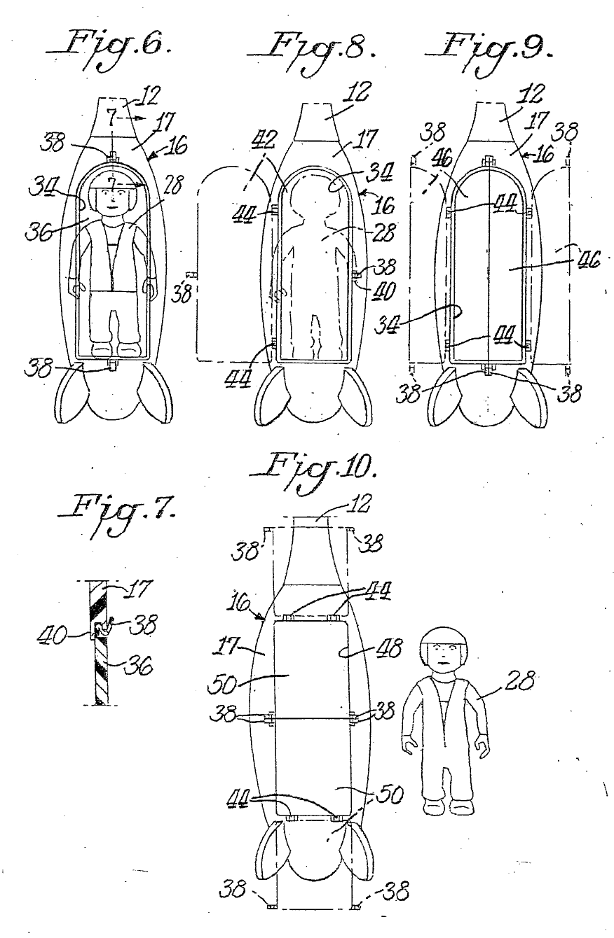

FIGS. 6-10 show various ways an openable cover may be arranged over an opening provided in a body portion 17 of handle 16, as opposed to the fixedly attached cover 24 shown in FIGS. 1-5. FIG. 6 shows a handle body portion 17 with an opening 34 provided therein for receiving a removable and replaceable cover 36 held in place by two snap-in latches 38. Snap-in latches 38 are received and retained in respective receptacles 40 formed in body portion 17 of handle 16, as best shown in FIG. 7. Latches 38 may be engaged to remove cover 36 from opening 34, permitting removal or insertion of figurine 28 from or within compartment 22 of handle 16.

FIG. 8 shows a handle body portion 17 with an opening 34 provided therein for receiving a cover 42 hingedly connected to body portion 17 with a pair of hinges 44. A snap-in latch 38 is provided on an edge of cover 42 opposing the edge attached to hinges 44. Snap-in latch 38 maybe received and retained in a receptacle 40 formed in body portion 17. Latch 38 may be engaged to pivot cover 42 away from opening 34, permitting removal or insertion of figurine 28 from or within compartment 22 of handle 16.

FIG. 9 shows a handle body portion 17 with an opening 34 provided therein for receiving a two-piece cover 46 hingedly connected in a vertical direction to body portion 17 with two pairs of hinges 44. Snap-in latches 38 are provided on an edge of each piece of cover 46 opposing the edge attached to hinges 44. Snap-in latches 38 maybe received and retained in respective receptacles 40 formed in body portion 17. Latches 38 may be engaged to pivot two-piece cover 46 away from opening 34, permitting removal or insertion of figurine 28 from or within compartment 22 of handle 16.

FIG. 10 shows a handle body portion 17 with an opening 48 provided therein for receiving a two-piece cover 50 hingedly connected in a horizontal direction to body portion 17 with two pairs of hinges 44. Snap-in latches 38 are provided on an edge of each piece of cover 50 opposing the edge attached to hinges 44. Snap-in latches 38 maybe received and retained in respective receptacles 40 formed in body portion 17. Latches 38 may be engaged to pivot two-piece cover 50 away from opening 34, permitting removal or insertion of figurine 28 from or within compartment 22 of handle 16.

Although hinges 40 and latches 38 are shown in specific quantities and at specific locations in FIGS. 6-10, more or less hinges 40 and latches 38 may be provided, at a variety of locations on handle 16 in accordance with the broad teachings of the present invention. Likewise, the covers shown in FIGS. 6-10 may have a variety of other shapes than shown in FIGS. 6-10, in accordance with the broad teachings of the present invention. Furthermore, other mechanisms may be used to connect and pivot the covers to the handles of the present invention.

FIGS. 11-13 show one version of how neck 12 and head 14 of toothbrush 10 may be removably connected to the handle of toothbrush 10. An alternate version of handle 16A is also shown in FIGS. 11-13. Handle 16A as shown may be shaped like a vehicle, such vehicles may include a race car, a submarine or an all terrain vehicle and includes a body portion 17A fixedly connected to or integrally formed with a transparent cover or window 24A. Window 24A displays a figurine 28, such as an action figure, that may be provided in a compartment 22A provided in handle 16A.

As further shown in FIGS. 11-13, a lower portion of neck 12 includes a retainer button 52 integrally connected to a spring arm 54, and a stiffener arm 56. Neck 12 and head 14 may be removably attached to handle 16A by depressing retainer button 52 in a direction as shown by arrow 53, moving neck 12 in a direction as shown by arrow 55, sliding stiffener arm 56 and the button 52/spring arm 54 combination into an opening 60 provided in body portion 17A of handle 16A, and releasing retainer button 52. Retainer button 52 extends through a retainer slot 58 provided in body portion 17A, and remains in slot 58 due to the spring force provided by spring arm 54. Neck 12 and head 14 may be removed from handle 16A by depressing retainer button 52, and pulling neck 12 and head 14 away from handle 16A.

As shown in FIGS. 14 and 15, the handle of the present invention need not be shaped like a toy, but rather may be configured as a conventional generally cylindrical toothbrush handle to act as display case for figurine 28 contained therein. As shown in FIG. 14, toothbrush 10 includes a neck section 12 interposed between a head 14 and a handheld display handle 62. Handle 62 preferably includes a hollowed-out compartment 64 with a transparent window 66 for retaining a figurine 28 (e.g., an action figure) therein. In this embodiment, handle 62 includes two hinged or separable and rejoinable sections, a top section 62A and a bottom section 62B, which sections when separable and rejoinable are threadably, snap-fit, force-fit or otherwise connected, preferably the connection contains an indicia band 68 (similar to indicia band 30) and a threadable connection via mating threads 70 provided on indicia band 68 and sections 62A, 62B. When top section 62A or bottom section 62B are separated by as preferably indicated being unscrewed from indicia band 70, figurine 28 may be removed from or inserted in compartment 64 of handle 62.

As shown in FIG. 15, toothbrush 10 includes a neck section 12 interposed between a head 14 and a handheld display handle 72. Handle 72 preferably includes a hollowed-out compartment 74 with a transparent window 76 for retaining a figurine 28 (e.g., an action figure) therein. In this embodiment, handle 72 may either threadably connect with a screw off top 78 (having neck 12 connected thereto), via mating threads 80, threadably connects with a screw off base 82, via mating threads 84, or threadably connects with screw off top 78 and screw offbase 82. When screw off top 78 or screw off base 82 are unscrewed from handle 72, figurine 28 may be removed from or inserted in compartment 74 of handle 72.

Any embodiment of the toothbrush handles 16, 16A, 62, 72 of the present invention may be permanently attached to neck 12 and head 14, or may be removably attached to neck 12 or head 14 using any of the attachment configurations shown in FIGS. 11-15. Preferably, however, the toothbrush handles of the present invention are removably attached to neck 12 and head 14 so that the handles may function more easily as a separate toy.

Head 14 of the present invention may have a generally flat face 18 that holds a plurality of tufts or bristles 20. Head 14 may have variety of shapes, including but not limited to circular, oval, square, rectangular, various regular or irregular shapes, etc.

Bristles 20 extending from face 18 may be coplanar with each other so that the outer surface of bristles 20 lie in a single plane. The invention, however, could be practiced where some or all of the bristles 20 extend outwardly a different distance than other bristles 20 to result in a stepped effect for the outer surface of bristles. In the illustrated embodiment as best shown in FIG. 2, bristles 20 extend outwardly from an outer surface 26 of head 14 approximately the same distance to create a generally flat surface or flat bristle trim for receiving the toothpaste.

While FIGS. 2, 4, 11, 14, and 15 illustrate conventional fiber form bristles, the term “bristles” as used herein is intended to be used in a generic sense as cleaning elements or massage elements and could include, for example, elastomeric fingers or walls arranged in a circular cross-section shape or any type of desired shape, including straight portions or sinusoidal portions.

The bristles 20 could be mounted to the tuft blocks or sections by extending through suitable openings in face 18 so that the base of bristles 20 is mounted within or below the surface of face 18 using conventional staple or in-mold tufting technology for mounting therein. If desired, the bristles could be embedded in an elastomeric material which would permit the bristles to have an independent motion. Such various forms of bristles may thus be used for the bristles used in any section of head 14.

It is to be understood that the specific illustration of the bristles is merely for exemplary purposes. The invention can, however, be practiced with various combinations of the same or different bristle configurations as disclosed in U.S. Pat. Nos. 5,609,890, 5,390,984, and 5,533,791, the disclosures of which being incorporated by reference herein in their entirety, and/or with the same or different bristle materials, such as nylon bristles, spiral bristles, rubber bristles, etc. Similarly, while FIGS. 1-7 illustrate the bristles to be generally perpendicular to face 18 of head 14, some or all of the bristles may be angled at various angles with respect to the outer surface of the bristle head. It is thereby possible to select the combination of bristle configurations, bristle materials and bristle orientations to achieve specific intended results, such as to create as much movement from the oscillating tuft heads to deliver additional oral health benefits like enhanced cleaning, tooth polishing, tooth whitening and/or massaging of the gums.

It is to be understood that the invention can be practiced by locating tufts of bristles in any otherwise open area of toothbrush head 14. Such tufts of bristles could be fixed bristles perpendicularly mounted or mounted at an angle to the exposed outer surface 26 of the head 14 or could be bristles mounted on an elastomeric base with a Shore A durometer in the range of about 0 to about 90, so as to be independently movable when pressure is applied. Such bristles in their normal condition could be either perpendicular or at an angle to the face 18 of head 14.

The invention may also be practiced where different sets of bristles have different colors. It is to be understood, however, that any combination of colors including only one color could be used for bristles 20. Likewise, neck 12 and handle 16 may have a variety of colors, and may be opaque, transparent, translucent, clear, etc.

Although the invention has been particularly shown and described with reference to certain preferred embodiments, it will be readily appreciated by those of ordinary skill in the art that various changes and modifications may be made therein without departing from the spirit and scope of the invention. It is intended that the claims be interpreted as including the foregoing as well as any such changes and modifications.

What is claimed is:

1. A method for marketing, promoting, cross-marketing or cross-promoting a first or second consumer product, comprising removably attaching an item to the first consumer product, wherein the item is adapted to be used with the second consumer product.

2. The method according to claim 1, wherein the item is a vehicle, figurine, toy, or sundry product.

3. The method according to claim 1, wherein the item is a novelty, promotional or collectible item.

4. The method according to claim 1, wherein the first consumer product is a toothbrush assembly, a bottle or a storage device.

5. The method according to claim 3, wherein the toothbrush assembly is a manual or powered toothbrush assembly.

6. The method according to claim 1, wherein the item is attached to the first consumer product by a string, a pouch, a capsule or by friction.

7. The method according to claim 1, wherein the item is removably attached to an inside or an outside portion of the first consumer product.

8. The method according to claim 1, wherein the second consumer product is a toy.

9. The method according to claim 1, wherein the item is interchangeable between the first and second consumer products.

10. The method according to claim 4, wherein the toothbrush assembly comprises:
a head connected to a neck, the head having a plurality of bristles extending outwardly therefrom;
a handle connected to the neck, the handle having a compartment provided therein; and
a compartment within which the item is removably attached.

11. The method according to claim 10, wherein the compartment comprises a cover which may be opened and reclosed whereby the item may be removed and replaced in the compartment.

12. The method as recited in claim 10, wherein the handle includes a top section connected to the neck and a bottom section distal from the neck, the top and bottom sections being joined in such a manner as to be hinged or to be separable and rejoinable, wherein the top and bottom sections form the compartment which retains the item.

13. The method according to claim 10, wherein a lower portion of the neck includes a stiffener arm and a retainer button integrally connected to a spring arm, the retainer button, spring arm, and stiffener arm removably connecting to the opening of the handle.

14. The method according to claim 13, wherein the retainer button extends through a retainer slot provided in the handle, and remains in the retainer slot due to a spring force provided by the spring arm.

15. The method according to claim 10, wherein the cover is transparent to make the item visible within the compartment of the handle.

16. The method according to claim 10, wherein the cover permanently connects to a body portion of the handle.

17. The method according to claim 10, wherein the cover removably connects to a body portion of the handle via at least one snap-in latch.

18 The method according to claim 10, wherein the cover connects to a body portion of the handle with at least one hinge and at least one snap-in latch.

19. The method according to claim 13, wherein the cover comprises two pieces, each cover piece connecting to the body portion of the handle via at least one hinge and at least one snap-in latch.

20. A toothbrush assembly as recited in claim 1, wherein the handle comprises two sections connected together with an indicia band.

21. The method according to claim 20, wherein the indicia band has threads that mate with threads provided on each section of the handle.

22. A method for marketing, promoting, cross-marketing or cross-promoting a toothbrush assembly or a toy, comprising removably attaching an item to the toothbrush assembly, wherein the toothbrush assembly comprises a head connected to a neck, the head having a plurality of bristles extending outwardly therefrom; a handle connected to the neck, the handle having a compartment provided therein; and a compartment within which the item is removably attached, wherein the item is adapted to be used with the toy set.
